(19) United States
(12) Patent Application Publication
(10) Pub. No.: US 2025/0163641 A1
(43) Pub. Date: May 22, 2025

(54) METHOD FOR PROVIDING A SUBSTRATE ON ONE FACE WITH A TINT AND A FUNCTIONAL COLORATION

(71) Applicant: RODENSTOCK GMBH, Munich (DE)

(72) Inventors: Herbert ZINNER, Rohrbach (DE); Simone HILBLE, Gräfelfing (DE); Kurt FISCHER, Frauenau (DE); Beate WIND, Regen (DE); Hans-Peter SOMMER, Munich (DE)

(21) Appl. No.: 18/839,834

(22) PCT Filed: Jan. 26, 2023
(86) PCT No.: PCT/EP2023/051929

§ 371 Date: Aug. 20, 2024

(30) Foreign Application Priority Data
Feb. 25, 2022 (DE) 10 2022 104 556.0

(51) Int. Cl. D06P 1/00; G02C 7/10

(52) U.S. Cl. CPC D06P 1/0004; D06P 1/004; G02C 7/102

(57) ABSTRACT

The present invention relates to a method for providing a substrate on one face with a tint and a functional coloration, comprising the following steps (a) to (d): (a) supplying a substrate to be provided on one face with a tint and a functional coloration, the substrate comprising a semifinished part manufactured from transparent plastic and having a first main face and a second main face which lies opposite the first main face and has a convex shape, (b) applying a tint to both main faces of the substrate supplied in step (a), (c) applying a functional coloration to the second main face of the substrate provided with a tint on both main faces in step (b), the functional coloration being brought about by at least one photochromic dye and the at least one photochromic dye being present in a photochromic coat material forming a polymeric coat on the substrate, and (d) post-processing the substrate provided with a functional coloration on the second main face in step (c), in such a way that the tint on the first main face is ablated, to give a substrate provided only on the second main face with a tint and a functional coloration.

The present invention relates to a method for providing a substrate on one face with a tint and a functional coloration.

Self-tinting lenses for glasses (spectacles), also called photochromic lenses, are able to respond to UV light. The lens darkens or lightens according to the intensity of the UV light impinging on it. The darkening or lightening of the lens is made possible by a functional coloration provided to the lens. This functional coloration is brought about by a photochromic dye which responds to the UV light irradiation by reversibly changing its molecular structure and hence its absorption characteristics as well. When the UV light irradiation subsides, the photochromic dye regains its original molecular structure and hence also its original absorption characteristics. A photochromic dye therefore enables reversible switching back and forth between dark and light tinting.

Generally speaking, the functional coloration is applied only to one of the two concave and convex main faces of the lens. Indeed, a functional coloration on both main faces is generally problematic, as it makes it difficult to control the effect associated with the functional coloration, such as the darkening or lightening of the lens. The underlying reason for this is that the intensity of the UV light impinging on the two concave and convex main faces is different. The UV light impinging on the convex main face is critical for the protection of the eye, as it is pointed directly at the glasses wearer. Normally, therefore, the functional coloration is applied to the convex main face of the lens, which serves as the front face.

The observations made above are also valid in the same way for the provision of the lens with a tint whose purpose is to give the lens a defined hue, alongside the functional coloration, this being a desire in particular with sunglasses. In contrast to the functional coloration, the tint involves the use of dyes which—apart from their absorption properties—possess no functional properties at all and are referred to accordingly as non-functional dyes. Like the functional coloration, the tint as well is typically applied to only one face of the lens, with the tint and the functional coloration then being located on the same main face of the lens. Generally speaking, the tint is applied to one face first, to the convex main face of the lens. Subsequently, the functional coloration is applied to the tint.

There are a variety of methods known in the prior art for providing lenses on one face with a tint and a functional coloration.

One example that may be stated in this context is the method described in EP 1 122 355 A1 for the tinting of a plastic lens. This method comprises a step of installing the lens in a predetermined position in a vapor deposition apparatus, a step of installing a base element for use for a dyeing operation in the vapor deposition apparatus, the base element bearing an applied dyeing medium, which contains a sublimable non-functional dye in a state of solution or finely particulate dispersion, to form a dye application surface, and the base element being arranged in such a way that the dye application surface faces the convex main face of the lens without being in contact therewith, and a step of heating the base element by a heating source under vacuum conditions in the vapor deposition apparatus, thereby causing sublimation of the non-functional dye of the dye application surface and resulting in vapor deposition of the sublimed non-functional dye onto the convex main face of the lens.

The functional coloration, which takes the form of a photochromic coat material, is applied subsequently to the convex main face of the lens, previously provided with the tint. The photochromic coat material forms a polymeric coat on the substrate. The polymeric coat with the functional coloration is unaffected by the tint located beneath it.

The approach described above is indeed suitable for providing one face of a lens with a tint and a functional coloration. However, the apparatus involved in the method known from EP 1 122 355 A1 is very complex, meaning that lenses obtained therewith are correspondingly costly. As noted above, the said method requires a specific vapor deposition apparatus with a dedicated base element on which a dye application surface is formed. An apparatus of this kind, though, cannot be used for other steps in the lens manufacturing process. Since, moreover, the non-functional dye of the dye application surface must be sublimable, it is also not possible to use just any non-functional dye in the said method. All of these drawbacks are an obstacle to the mass manufacture of lenses.

It is an object of the present invention, therefore, to provide a method which is capable of providing a substrate on one face with a tint and a functional coloration, where the method to be provided should enable this in a way which involves simple apparatus and is therefore inexpensive.

The object set above is achieved by a method for providing a substrate on one face with a tint and a functional coloration, with the features of claim 1. Preferred embodiments are disclosed in the dependent claims.

The method of the invention for providing a substrate on one face with a tint and a functional coloration, also referred to below simply as the method of the invention, comprises the following steps (a) to (d):
(a) supplying a substrate to be provided on one face with a tint and a functional coloration, the substrate comprising a semifinished part manufactured from transparent plastic and having a first main face and a second main face which lies opposite the first main face and has a convex shape,
(b) applying a tint to both main faces of the substrate supplied in step (a),
(c) applying a functional coloration to the second main face of the substrate provided with a tint on both main faces in step (b), the functional coloration being brought about by at least one photochromic dye and the at least one photochromic dye being present in a photochromic coat material forming a polymeric coat on the substrate, and
(d) post-processing the substrate provided with a functional coloration on the second main face in step (c), in such a way that the tint on the first main face is ablated, to give a substrate provided only on the second main face with a tint and a functional coloration.

The method of the invention allows a substrate to be provided on one face with a tint and a functional coloration in a manner which involves simple apparatus and is therefore inexpensive. Because both main faces of the substrate are first provided with a tint, there is no requirement for any specially adapted apparatus, such as a vapor deposition apparatus, which permits only one of the two main faces of the substrate to be provided with a tint. Accordingly, in the method of the invention, the substrate can be tinted in a conventional dyeing unit. As a result, at the same time, the requirements imposed on the non-functional dye used for the tint are less exacting, as the dye does not have to be sublimable. All of this favors mass manufacture of lenses on the basis of the method of the invention.

In the text below, the method of the invention for providing a substrate on one face with a tint and a functional coloration, said method being represented schematically in FIG. 1, is described in more detail:

In step (a) of the method of the invention, a substrate to be provided on one face with a tint and a functional coloration is supplied. In accordance with the present invention, the substrate in question is a semifinished part manufactured from transparent plastic. A semifinished part, occasionally also referred to as a blank, is understood presently to be a semi-finished product, which differs from a finished product in that it can as yet not be used directly for a predetermined purpose—for instance, as a lens for glasses.

The substrate has a first main face and a second main face lying opposite the first main face. The first main face of the substrate corresponds to the back of the later lens, facing the glasses wearer, while the second main face of the substrate corresponds to the front of the later lens, facing away from the glasses wearer. In accordance with the present invention, the second main face of the substrate has a convex shape. With regard to the shape of the first main face of the substrate, there is no further restriction on the method of the invention. Accordingly, for example, the first main face of the substrate may have a concave or planar shape. In contrast to an unfinished workpiece, which still has plane-parallel main faces, the semifinished part serving as a substrate, on account of the shape of the second main face, is already recognizable as a lens. Accordingly, the second main face of the substrate already corresponds to the eventual optically active surface. As compared with an unfinished workpiece, then, the semifinished part has already been brought into a fundamental geometric shape corresponding roughly to that of the finished product.

The semifinished part serving as a substrate is manufactured from transparent plastic. Transparent plastic has the advantage over mineral glass that it has a lower density and is therefore lighter for a given substrate size. Furthermore, relative to mineral glass, transparent plastic is more shatterproof. Corresponding plastics materials for the manufacture of transparent plastics are known to the skilled person. Accordingly, the semifinished part serving as the substrate may be manufactured, for example, from polythiourethane, polymethyl methacrylate, polycarbonate, polyacrylate, polydiethylene glycol bisallylcarbonate or combinations thereof, in principle, other transparent plastics materials may also be used.

In step (b) of the method of the invention, a tint is applied to both main faces of the substrate provided in step (a). The sole purpose of the tint is to give the substrate a particular hue. As mentioned earlier, dyes are used in this context that—apart from their absorption properties—possess no functional properties at all, and so, among other things, do not enable reversible switching back and forth between dark and light tinting. Accordingly, non-functional dyes as used in the method of the invention are non-photochromic. Various classes of non-functional dyes are described in the prior art. Frequently these are azo dyes, cyanine dyes, anthraquinone dyes or the like, of the kind widely used in the conventional tinting of lenses. The skilled person routinely selects a suitable non-functional dye or a mixture of suitable non-functional dyes.

As far as the applying of the tint in step (b) is concerned, there is no further restriction on the method of the invention. In one preferred embodiment, the applying of the tint in step (b) is accomplished by immersing the substrate into a dyeing tank which contains at least one non-functional dye in dispersion or solution in a liquid medium. As a result of being immersed into the dyeing tank, the substrate is provided entirely with a tint. As well as the second main face, therefore, the first main face of the substrate is also provided with the tint. The dyeing tank is not subject to any particular limitation as long as it is able to provide the substrate with a tint.

The dyeing tank, which may be part of a conventional dyeing unit which can be used for a multiplicity of applications, is filled with a liquid medium. The at least one non-functional dye is in dispersion or solution in this medium. Without being limited to this, the liquid medium may be a water bath. To promote the application of the tint on the substrate, the liquid medium is heated typically to a temperature in the range from 60 to 100° C., as for example to a temperature in the range from 75 to 95° C., with the adjustable heating temperature of the liquid medium being dependent not least on its boiling point. At heightened temperature, the take-up of the non-functional dye by the surface area of the substrate is promoted. More in-depth details concerning the dyeing process in a dyeing tank are known to the skilled person.

The extent of dye take-up may be guided in a targeted way, lastly, by way of the immersion time. The extent of dye take-up is deemed to increase with the immersion time. With increasing extent of dye take-up there is a decrease in turn in the transmittance of the substrate provided on both main faces with a tint in step (b). When choosing the immersion time, it should be borne in mind that the desired transmittance, also referred to as the target transmittance, is attained only after the post-processing in step (d). Accordingly, the transmittance increases as a result of the ablation of the tint on the first main face, optionally together with a part of the underlying substrate material, as described in more detail later on below in connection with step (d). The transmittance before ablation is consequently lower than the transmittance after ablation, i.e., lower than the target transmittance.

In step (c) of the method of the invention, a functional coloration is applied to the second main face of the substrate provided on both main faces with a tint in step (b). The functional coloration serves to give the substrate a defined functional property. In accordance with the present invention, the basis for the functional property is a reversible change in the absorption characteristics, owing to an external stimulus such as UV light, for instance. Correspondingly, the functional coloration is brought about by at least one photochromic dye. Various classes of photochromic dyes are described in the prior art. Frequently the dyes involved are chromenes, viologens, fulgides and fulgimides, and also, in particular, spiro compounds such as spirooxazines or spiropyrans, but are not limited to these. The skilled person routinely selects a suitable photochromic dye or a mixture of suitable photochromic dyes.

As far as the applying of the functional coloration in step (c) is concerned, there is no further limitation on the method of the invention, as long as the at least one photochromic dye is present in a photochromic coat material. In one preferred embodiment, the applying of the functional coloration in step (c) is accomplished by spin coating using such a material. As mentioned earlier, the photochromic coat material forms a polymeric coat on the substrate. The photochromic coat material is therefore not removed, but instead remains on the substrate together with the at least one photochromic dye it contains. If the functional coloration is applied in step (c) by spin coating, this is done expediently only on the second main face of the substrate. A functional coloration applied on the first main face of the substrate would be ablated in any case in step (d), together with the tint located beneath it. Instead of spin coating, the functional coloration may also be applied in step (c) by means of dipping methods. In this case, of course, the substrate is provided entirely with a functional coloration. As well as the second main face, then, the first main face of the substrate is also provided with the functional coloration.

In step (d) of the method of the invention, the substrate provided on the second main face with a functional coloration in step (c) is post-processed. The post-processing in step (d) is accomplished in such a way that the tint on the first main face is ablated. If a functional coloration is located over the tint on the first main face, such coloration originating, for example, from the implementation of the dipping method in step (c), then it is ablated at the same time. The ultimate result of the post-processing in step (d) is a substrate which is provided only on the second main face and hence on one face with a tint and a functional coloration.

As far as the post-processing in step (d) is concerned, there is no further restriction on the method of the invention. In one preferred embodiment, the post-processing in step (d) is accomplished by at least one form of surface working selected from the group consisting of milling, grinding and polishing. In principle, however, any other form of surface working is conceivable, provided it ensures residue-free removal of the tint.

Optionally, as well as the tint on the first main face, a part of the substrate material lying beneath it is also ablated in step (d). It is consequently possible to adjust the geometric shape of the substrate to the later requirements, in relation, for instance, to the desired optical effect, as for example in relation to the desired refractive power, arising from an opthalmological prescription. It should be borne in mind here that the ablation of the substrate material likewise has an influence on the transmittance. This must be taken into account when applying the tint in step (b). If a comparatively large amount of substrate material has to be ablated in step (d) in order to achieve the desired optical effect, a longer time for immersion into the dyeing tank should be provided in step (b) in order to attain the target transmittance.

As well as steps (a) to (d), the method of the invention may further comprise a step of applying one or more finishing coats to at least one of the two main faces of the substrate provided only on the second main face with a tint and a functional coloration, also referred to hereinafter as step (e). In step (e), typically, as well as the second main face of the substrate, provided with a tint and a functional coloration, the first main face of the substrate is also finished. Typical finishing coats include, but are not limited to, hardcoats, serving for protection from scratches, interference/antireflection coats, which serve to minimize reflections, and easy-care coats, occasionally also referred to as topcoats or cleancoats, which serve to repel water and dirt. The skilled person is aware of corresponding measures for the application of such finishing coats. Where a photochromic coat material is used when applying the functional coloration in step (c), it may be necessary, prior to the finishing in step (e), to have to remove excess residues of the photochromic coat material at the edges of the substrate.

In accordance with the present invention, the substrate is provided with a tint and a functional coloration only on the second main face, which has a convex shape. However, the method of the invention may be very readily modified in such a way that instead of the second main face, the first main face of the substrate, which has a concave or planar shape, for example, is provided with a tint and a functional coloration. Correspondingly, in step (c) the functional coloration is applied to the first main face of the substrate and in step (d) the tint is then ablated on the second main face, optionally together with a part of the substrate material lying beneath it.

The substrate obtainable with the method of the invention, provided on one face with a tint and a functional coloration, has diverse possibilities for use and may be employed, for example, as a lens for glasses. The substrate is then further edge-machined in order to be fitted into a glasses frame.

### DESCRIPTION OF THE FIGURE

FIG. 1 shows a schematic representation of the method of the invention. The step (e) likewise represented in FIG. 1 is optional.

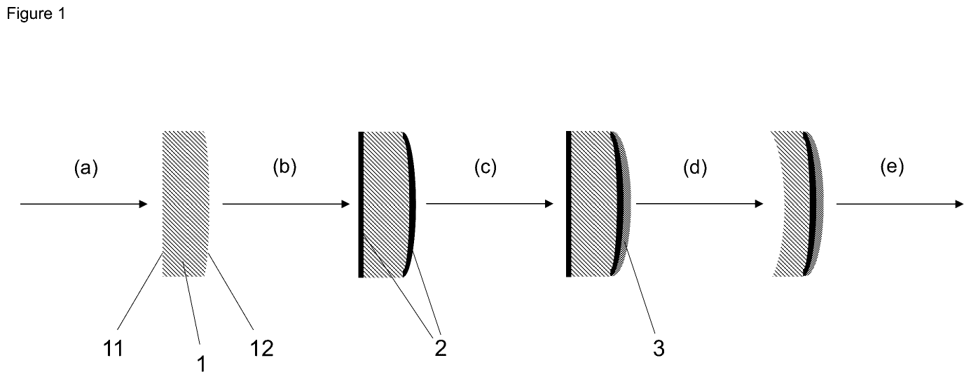

### LIST OF THE REFERENCE SYMBOLS

1 substrate (semifinished part manufactured from transparent plastic)
11 first main face of the substrate
12 second main face of the substrate
2 tint
3 functional coloration

### EXAMPLE

The working example which follows serves for further elucidation of the present invention, but does not limit that invention.

In accordance with the method of the invention, substrates were provided on one face with a tint and a functional coloration. For the tint, different non-functional dyes were used, such as anthraquinone dyes or azo dyes. For the functional coloration, conversely, the same photochromic dye was always used.

Substrates used were semifinished parts manufactured initially from transparent plastic, having a first main face, which had a planar shape, and a second main face, which had a convex shape. The substrates were subsequently immersed into a dyeing tank. This tank contained the respective non-functional dye for the tint, in aqueous solution. By immersion into the dyeing tank, the substrates were entirely provided with the tint. The immersion time was chosen such that the target transmittance was attained after the post-processing. The dyeing process took place at a temperature in the range from 60 to 100° C.

Following this, the transmittance of the substrates at a wavelength of 380 to 780 nm was measured, the transmittance being weighted with the relative spectral light sensitivity (luminous efficiency function V-lambda). This was done using a transmittance measuring instrument in the form of the Lens Colour Analyser TFM-1 from tec5 AG. The resultant data values are listed in table 1, where they are referred to as transmittance before ablation. Owing to the facts on the one hand that initially both main faces of the substrates were provided with a tint and on the other hand that the semifinished parts serving as substrates were still relatively thick, the transmittance before ablation was comparatively low.

Next, the functional coloration was applied to the second main face of the entirely tinted substrates. This was accomplished either by spin coating or by means of dipping methods, using a photochromic coat material containing the photochromic dye for the functional coloration.

Following the application of the functional coloration, the substrates were stored temporarily in a store for semi-finished products, before finally they underwent post-processing. This was accomplished by a suitable form of surface working, in which, as well as the tint on the first main face, a part of the substrate material lying beneath it was also ablated, to achieve the desired optical effect. Under the conditions stated above, the transmittance of the substrates was measured again, producing the data values identified in table 1 as transmittance after ablation. These values corresponded to the target transmittance. As a result of the ablation of the tint on the first main face together with a part of the substrate material lying beneath it, there was a corresponding increase in the transmittance of the substrates, as is evident in each case from a comparison of the transmittance after ablation with the transmittance before ablation.

TABLE 1

| | Transmittance | Transmittance |
|---|---|---|
| Hue of substrate after tinting | before ablation [%] | after ablation [%] |
| brown | 11.5 | 55.0 |
| green | 22.2 | 50.0 |
| gray | 18.0 | 50.0 |

A hardcoat material was then applied by means of dipping methods to both main faces of the substrates provided on one face with a tint and a functional coloration. Atop this, subsequently, an interference/antireflection coat was further applied. The resultant substrates possessed all of the required properties and, accordingly, constituted roughly rounded lenses, which could then be edge-machined in order to be fitted into a glasses frame.

As can be seen from the working example, the method of the invention enables a substrate to be provided on one face with a tint and a functional coloration in a manner which involves simple apparatus and is therefore inexpensive.

1. A method for providing a substrate on one face with a tint and a functional coloration, comprising the following steps (a) to (d):
(a) supplying a substrate to be provided on one face with a tint and a functional coloration, the substrate comprising a semifinished part manufactured from transparent plastic and having a first main face and a second main face which lies opposite the first main face and has a convex shape,
(b) applying a tint to both main faces of the substrate supplied in step (a),
(c) applying a functional coloration to the second main face of the substrate provided with a tint on both main faces in step (b), the functional coloration being brought about by at least one photochromic dye and the at least one photochromic dye being present in a photochromic coat material forming a polymeric coat on the substrate, and
(d) post-processing the substrate provided with a functional coloration on the second main face in step (c), in such a way that the tint on the first main face is ablated, to give a substrate provided only on the second main face with a tint and a functional coloration.

2. The method as claimed in claim 1, wherein the first main face of the substrate has a concave or planar shape.

3. The method in claim 1, wherein the semifinished part serving as the substrate is manufactured from polythiourethane, polymethyl methacrylate, polycarbonate, polyacrylate, polydiethylene glycol bisallylcarbonate or combinations thereof.

4. The method claim 1, wherein the applying of the tint in step (b) is accomplished by immersing the substrate into a dyeing tank which contains at least one non-functional dye in dispersion or solution in a liquid medium.

5. The method as claimed in claim 1, wherein the applying of the functional coloration in step (c) is accomplished by spin coating or by means of dipping methods.

6. The method in of claim 1, wherein the post-processing in step (d) is accomplished by at least one form of surface working selected from the group consisting of milling, grinding and polishing.

7. The method of claim 1, wherein, as well as the tint on the first main face, a part of the substrate material lying beneath it is also ablated in step (d).

8. The method in claim 1, further comprising the following step (e):
applying one or more finishing coats to at least one of the two main faces of the substrate provided only on the second main face with a tint and a functional coloration.
